(19) United States
(12) Patent Application Publication
(10) Pub. No.: US 2006/0050860 A1
(43) Pub. Date: Mar. 9, 2006

(54) Context sensitive telephony wizard method and apparatus

(76) Inventor: Charles Baker, Apex, NC (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 11/220,973

(22) Filed: Sep. 6, 2005

Related U.S. Application Data
(63) Continuation of application No. 09/930,054, filed on Aug. 14, 2001.

(51) Int. Cl. H04M 3/42

(52) U.S. Cl. 379/207.04

(57) ABSTRACT

A method, apparatus, user-interface, and system to enable users to take advantage of new and existing telephony features. An internet access device determines its current call state, and displays help information, or menu options showing the features available in the current state. Internet access devices may download additional help information or menu items when new features become available.

### BACKGROUND

1. Field of the Invention

Aspects of the present invention relate in general to telephony, and a context-sensitive apparatus and method to enable users to take advantage of new and existing telephony features.

2. Description of the Related Art

Ever since Alexander Graham Bell invented the first telephone, people have been using the telephone to communicate. With the advent of Intelligent Network (IN) and Next Generation Network (NGN) features, users now have the option of combining additional useful features with their phone service. At one estimate, from Bellcore spec # TR-NWT-000391, over 3,500 different calling features are contemplated. Of these 3,500 possible features, approximately 35 features are available from various phone companies. Often, features are implemented by adding specialized buttons to a telephone (e.g., a “hold” button for call holding), or by pressing a specialized button combination (e.g., pressing “*082” for call blocking).

Of the approximately 35 available features, only a small fraction is actually utilized by the public.

### BRIEF DESCRIPTION OF THE DRAWINGS

FIG. 1 is a diagram of a context-sensitive system embodiment to enable users to take advantage of new and existing telephony features.

FIG. 2 is a block diagram of a context-sensitive apparatus embodiment to enable users to take advantage of new and existing telephony features.

FIG. 3 is a block diagram of a context-sensitive apparatus embodiment to enable users to take advantage of new and existing telephony features.

FIG. 4 is an illustration of a context-sensitive graphical user interface embodiment to enable users to take advantage of new and existing telephony features.

FIG. 5A-5D are illustrations of a context-sensitive text caller-box embodiment to enable users to take advantage of new and existing telephony features.

FIG. 6 is an illustration of a context-sensitive wireless phone embodiment to enable users to take advantage of new and existing telephony features.

FIGS. 7A-7B are state diagrams of a context-sensitive method to enable users to take advantage of new and existing telephony features.

FIGS. 8A-8B are flowcharts of a context-sensitive method to enable users to take advantage of new and existing telephony features.

FIG. 9 is a flowchart of an alternate embodiment of a context-sensitive method to enable users to take advantage of new and existing telephony features.

### DETAILED DESCRIPTION

What is needed is an easy-to-use context-sensitive apparatus and method to enable users to take advantage of new and existing telephony features.

Aspects of the present invention include method, apparatus, user-interface, and system to enable users to take advantage of new and existing telephony features. As will be described below, the embodied method may be performed over any communications network as is known in the art. In some embodiments, the embodied method may be performed on an Internet Access Device (IAD) in conjunction with an Intelligent Network (IN) or Next Generation Network (NGN), public switch telephone network (PSTN), plain old telephone service (POTS), Integrated Services Digital Network (ISDN), SIP (Session Initiation Protocol), International Telecommunications Union (ITU) H.323, Real Time Transport Protocol (RTTP), or any Voice Over Internet Protocol standard.

The term “call,” as used herein, may refer to audio (e.g., telephone), video, text (e.g. “instant text messaging” services) and multimedia based messages, or any other packet-based message communication as is known in the art.

Calls are any real-time or near-real-time audio, video, text, and multimedia-based message transmissions that take place over a network. Calls may further include any “on-line” message transmissions. Examples of such transmissions include, but are not limited to, any user-to-user or user-to-multi-user communication that involves the electronic conveying of digital-packet messages. An example of such a call includes a electronic text “chat” or “talk” messaging, electronic-mail, video-conferencing, internet telephony (“voice over internet protocol”), or instant text messaging.

Call features are any functions related to calls, as are known in the art. Such call features may include, but are not limited to: call conferencing, call rejection, placing calls on hold, call waiting, call forwarding, remote call forwarding, selective call forwarding, 3-way calling, speed dialing variations, calling number delivery, calling number block, private line, 170. Examples of other devices include, but are not limited to, servers, computers, workstations, terminals, input devices, output devices, printers, plotters, routers, bridges, cameras, sensors, or any other such device known in the art.

Network 10 may be any communication network known in the art, including a conventional telephone network, the Internet, a local-area-network (LAN), a wide-area-network (WAN), or any system that links a internet access device 120 to a telephone 10. Further, network 110 may be of configured in accordance with any topology known in the art, including star, ring, bus, or any combination thereof.

Internet access device 120 is coupled to a telephone network 110 that supports the receipt and transmission of digital packets. Telephone network server 150 may be configured to allow different networks to communicate, as well as communicate with a public switch telephone network, plain old telephone service, Integrated Services Digital Network, Session Initiation Protocol, International Telecommunications Union (ITU) H.323, Real Time Transport Protocol, any Voice Over Internet Protocol standard, or any other telephone network. In some system embodiments, a internet access device 120 may obviate the use of internet access devices 120 by conference call participants.

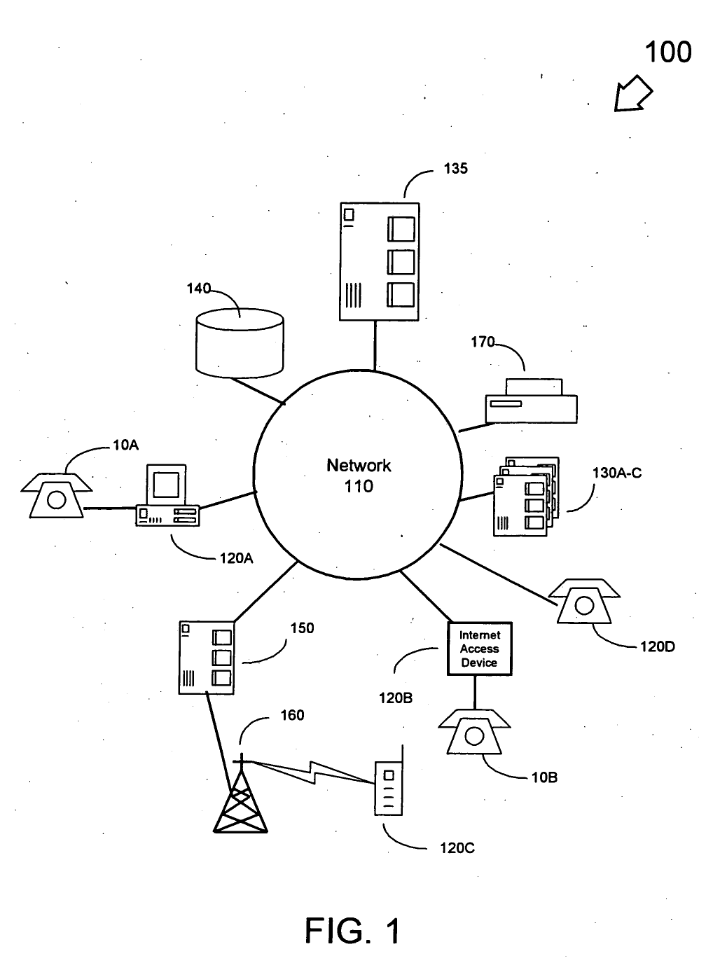

Furthermore, as shown in FIG. 1 telephone network server 150 may be coupled to wireless base station 160, which allows communication to a wireless phone embodiment of an internet access device 120C. In other embodiments, internet access device 120D may be a phone that can connect directly to network 110.

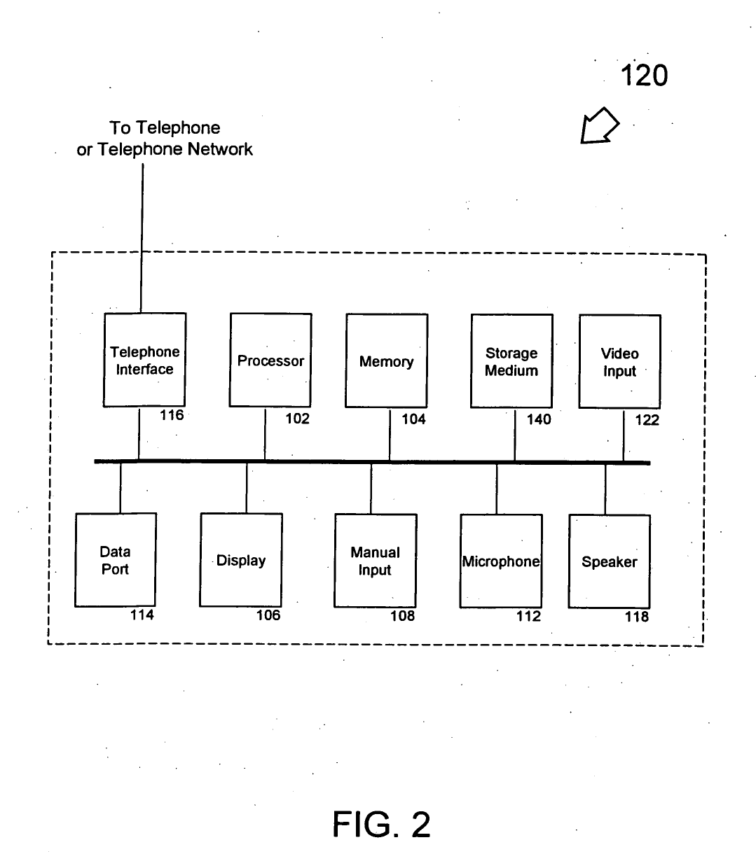

Embodiments will now be disclosed with reference to a functional act diagram of an exemplary internet access device 120 of FIG. 2, constructed and operative in accordance with an embodiment of the present invention. Internet access device 120 runs a multi-tasking operating system and includes at least one processor or central processing unit (CPU) 102. Processor 102 may be any microprocessor or micro-controller as is known in the art.

The software for programming the processor 102 may be found at a computer-readable storage medium 140 or, alternatively, from another location across network 110. Processor 102 is coupled to computer memory 104. Internet access device 120 may be controlled by an operating system (OS) that is executed within computer memory 104.

Processor 102 communicates with a plurality of peripheral equipment, including telephone network interface 116. Additional peripheral equipment may include a display 106, manual input device 108, storage medium 140, microphone 112, video input 122, and data port 114.

Display 106 may be a visual display such as a cathode ray tube (CRT) monitor, a liquid crystal display (LCD) screen, touch-sensitive screen, or other monitors as are known in the art for visually displaying images and text to a user.

Manual input device 108 may be a conventional keyboard, keypad, mouse, trackball, or other input device as is known in the art for the manual input of data.

Storage medium 140 may be a conventional read/write memory such as a magnetic disk drive, floppy disk drive, compact-disk read-only-memory (CD-ROM) drive, transistor-based memory or other computer-readable memory device as is known in the art for storing and retrieving data. Significantly, storage medium 140 may be remotely located from processor 102, and be coupled to processor 102 via a network 110 such as a local area network, a wide area network, or the Internet.

Microphone 112 may be any suitable microphone as is known in the art for providing audio signals to processor 102. In addition, a speaker 118 may be attached for reproducing audio signals from processor 102. Video input 122 may be a digital or analog video camera device to record still or moving images. In some embodiments, video input 122 may be a scanner device. It is understood that microphone 112, speaker 118, and video input 122 may include appropriate digital-to-analog and analog-to-digital conversion circuitry as appropriate.

Data port 114 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data port 114 may be any interface as known in the art for communicating or transferring files across a computer network, examples of such networks include Transmission Control Protocol/Internet Protocol (TCP/IP), Ethernet, Fiber Distributed Data Interface (FDDI), token bus, or token ring networks. In addition, on some systems, data port 114 may consist of a modem coupled to telephone network interface 116. Similarly, telephone network interface 116 provides connectivity enabling internet access device 120 to communicate with a telephone network 150. Thus, the telephone network interface 116 allows the internet access device 120 to communicate and process input and output from a telephone line.

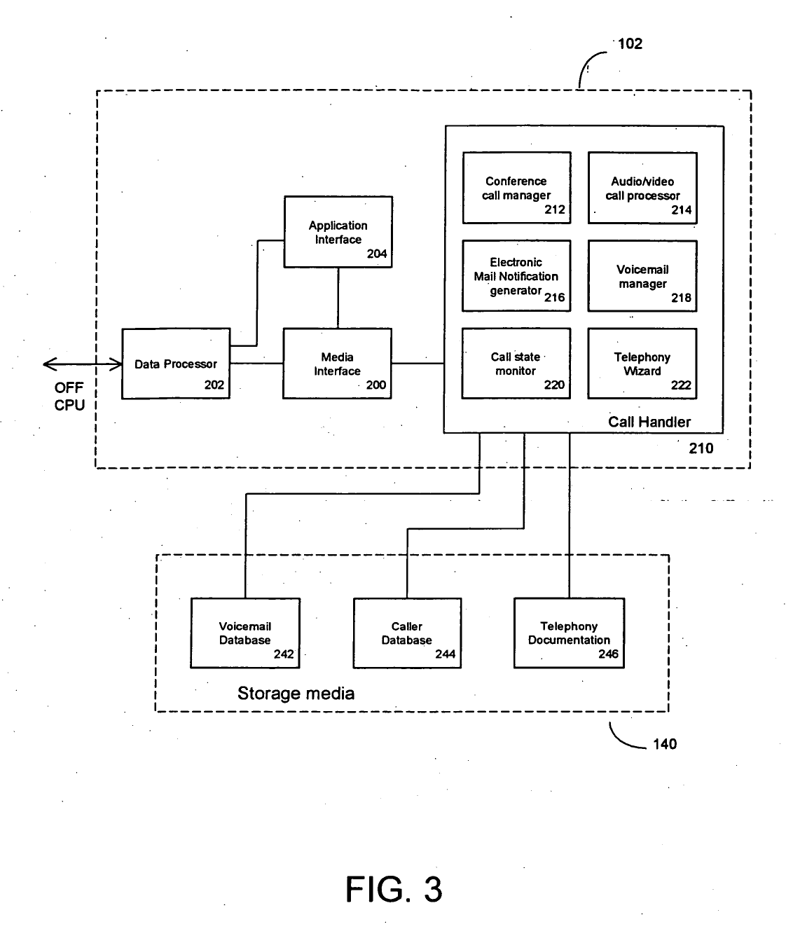

FIG. 3 is an expanded functional act diagram of CPU 102 and storage medium 140, constructed and operative in accordance with an embodiment of the present invention. It is well understood by those in the art, that the structural elements of FIG. 3 may be implemented in hardware, firmware, or as software instructions and data encoded on a computer-readable storage medium 140. As shown in FIG. 3, central processing unit 102 comprises a data processor 202, an application interface 204, a media interface 200, and a call handler 210. These structures may be implemented as hardware, firmware, or software encoded on a computer readable medium, such as storage media 140. In addition, as shown in FIG. 3, storage media 140 may also contain a voicemail database 242, a caller database 244 and telephony documentation 246.

Data processor 202 interfaces with display 106, manual input device 108, storage medium 140, microphone 112, data port 114, video input 122, memory 104, speakers 118, and telephone network interface 116. The data processor 202 enables central processing unit 102 to locate data on, read data from, and write data to these components.

Application interface 204 enables processor 102 to take some action with respect to a separate software application or entity. For example, application interface 204 may take the form of a windowing user interface, as is commonly known in the art.

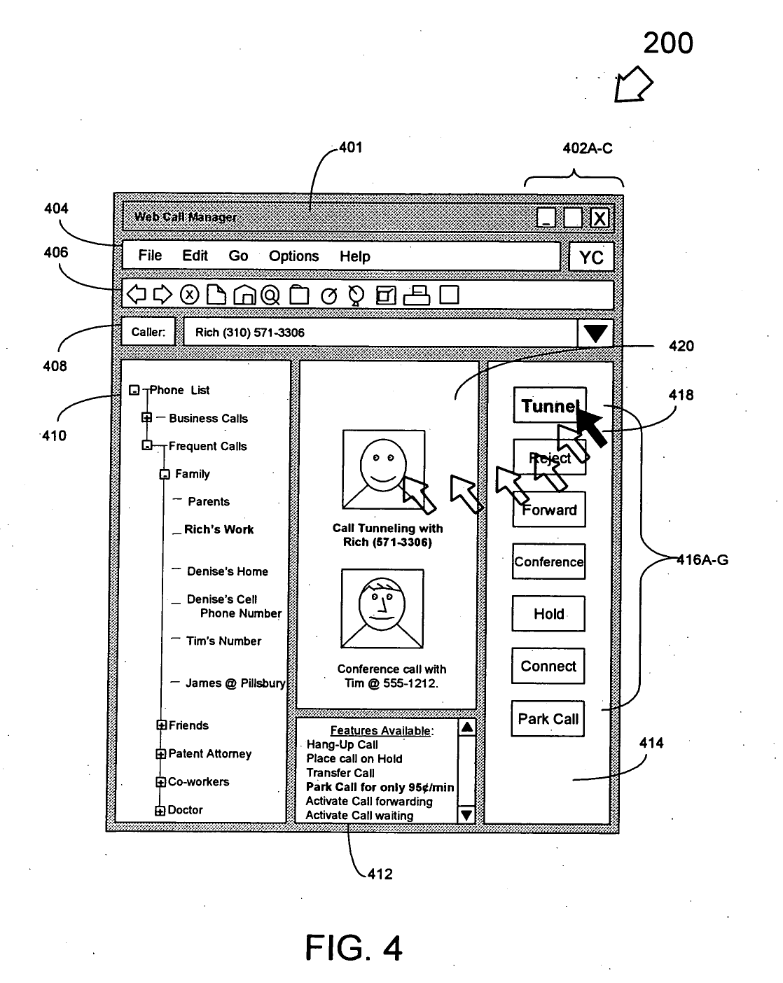

Media interface 200 is a user call interface. In some embodiments, the media interface 200 may be a stand-alone program, or a web-browser window. An example of such a media interface window is shown in FIG. 4, constructed and operative in accordance with an embodiment of the present invention. Media interface window 200 comprises title bar 401, window control buttons 402A-C, menu bar 404, button bar 406, address bar 408, phone-list frame 410, main frame 420, status frame 412, and control frame 414.

In some embodiments, main frame 420 displays a picture of the current caller retrieved from a caller database 244. In such embodiments, using the mouse pointer 418, users may either click control buttons 416A-G, or “drag-and-drop” callers listed in the phone list frame 410, or pictures of the caller in the main frame 420 to control buttons 416A-G in the control frame 414. Users may similarly interact with features listed in status frame 412. In some embodiments, status frame 412 lists features available depending upon the context or internet access device's state of operation. Media interface 200 then selects the appropriate structure to execute the functionality specified by the control button 416.

Returning to FIG. 3, call handler 210 may further comprise a conference call manager 212, an audio/video call processor 214, an electronic mail notification generator 216, voicemail manager 218, a call state monitor 220, and a telephony wizard 222.

Conference call manager 212 allows media interface to 200 communicate with multiple parties in a conference call. In addition, conference call manager 212 determines which parties receive communication packets, and the communication packets received. For example, suppose parties A, B, and C are participating in a conference call with internet access device 120D. The conference call manager 212 routes signals from internet access device 120D to parties. A, B, and C.

Audio/video call processor 214 allows media interface 200 to utilize video input 122, microphone 112, speaker 118 and display 106 for audio or multimedia-video-based calls.

Electronic mail notification generator 216 allows media interface 200 to communicate through text-based messaging systems, such as electronic mail or, in some embodiments, instant-messaging programs.

Voicemail manager 218 communicates with media interface 200 and stores messages in a voicemail database 242.

Call state monitor 220 determines the current state of operation of the internet access device 120. In some embodiments, the state may be defined by the functionality being processed by the internet access device 120. In other embodiments, the state may be defined by the context in which an operation takes place.

The telephony wizard 222 determines the options, features, and related messages available for display, depending upon the state determined by call state monitor 220. A list of these options, features, and related messages may be stored as telephony documentation 246. In some embodiments, telephony documentation may be a database or a text file. In other embodiments, telephony documentation may also include the relevant software code to enable hardware, firmware, or software-encoded instructions to execute the state-related features. Related messages may include help information, instructions on how to enable features, or relevant downloaded messages. An example of a relevant message may be a downloaded or previously existing advertisement or notice related to enabling a call feature. In some embodiments, the relevant message may include star code information, such as prompting the use of a “*-number-number” combination to activate a telephone feature. In other embodiments, the telephony documentation may include computer software code to automatically dial the star code to implement the desired feature. When new features, such as “parking calls,” “call tunneling” or “three-way-calling” are added by a carrier, telephony wizard 222 may determine that these feature options should be prominently displayed by media interface 220.

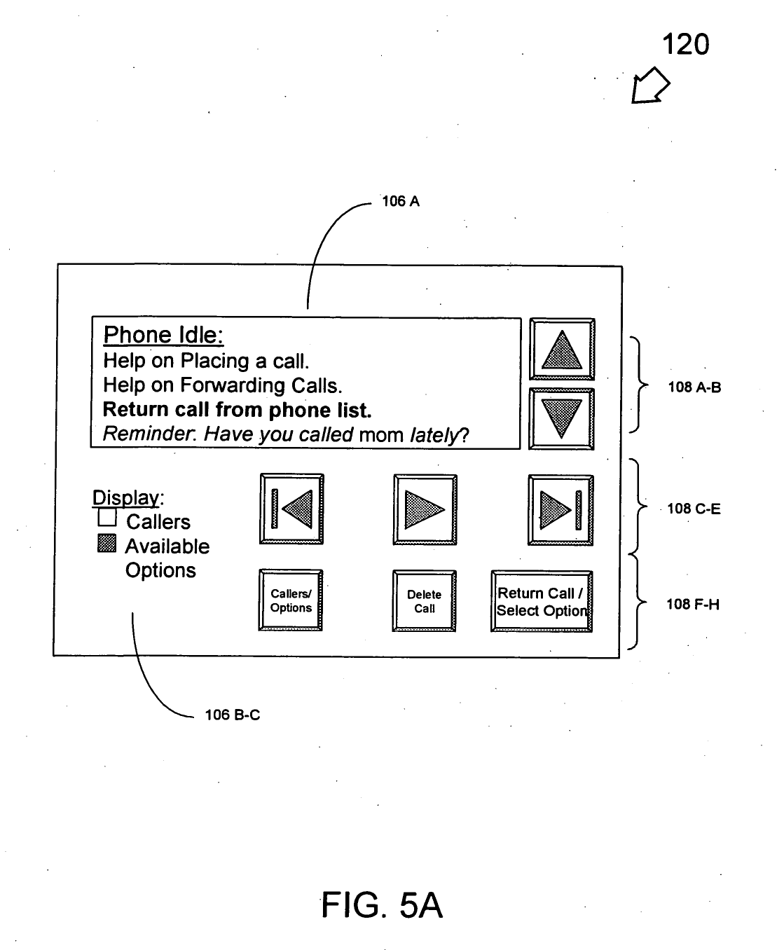

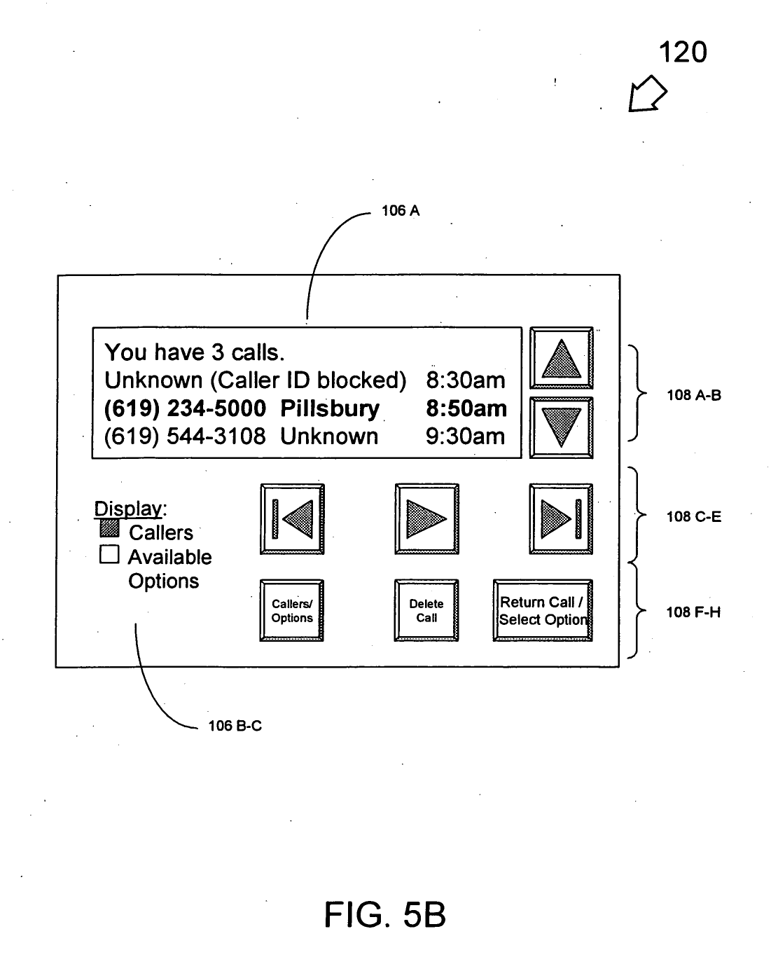

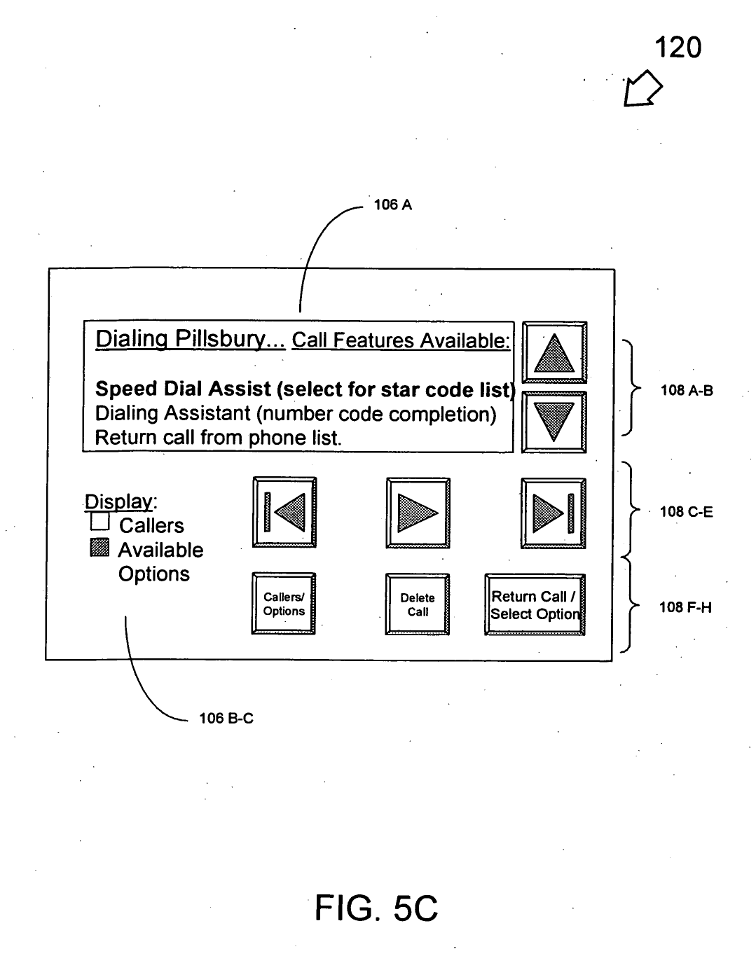

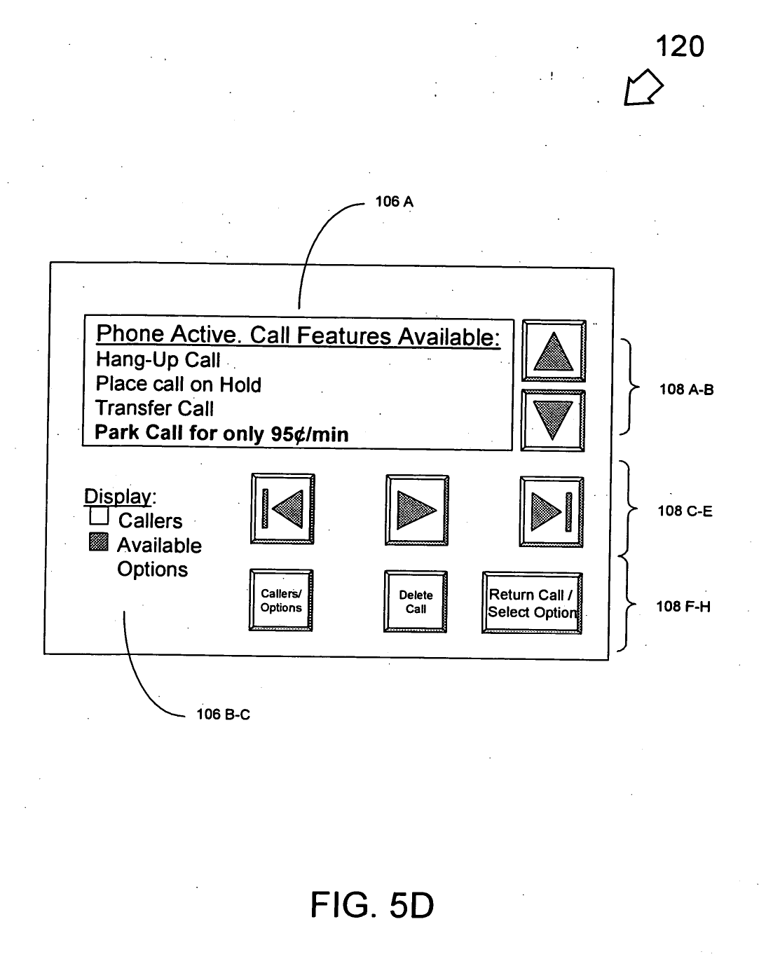

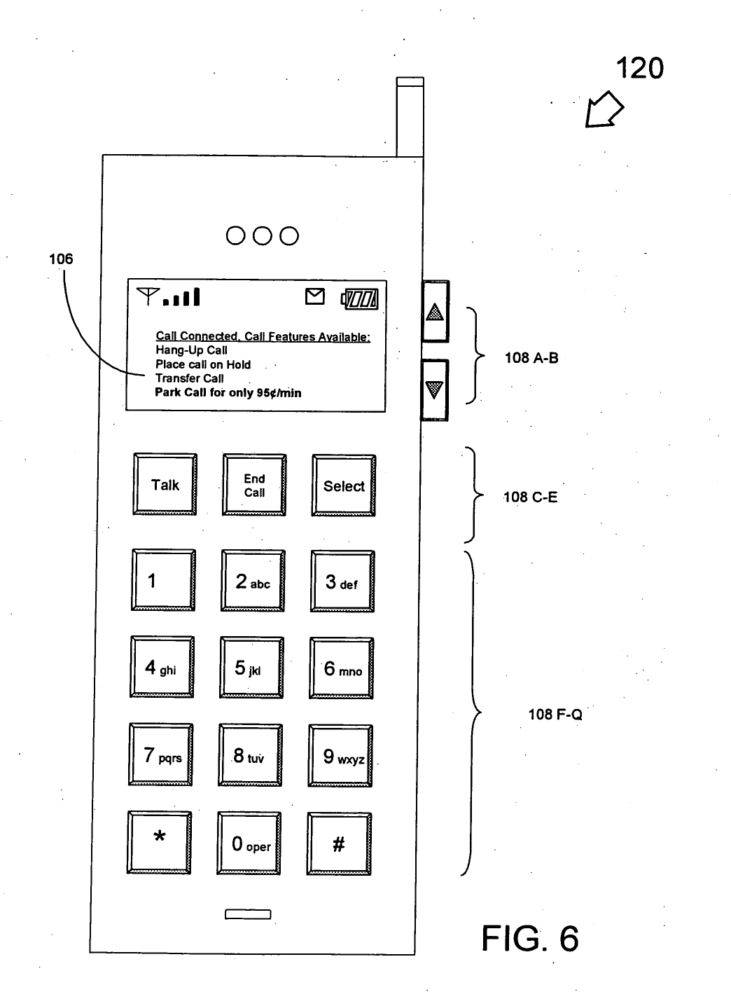

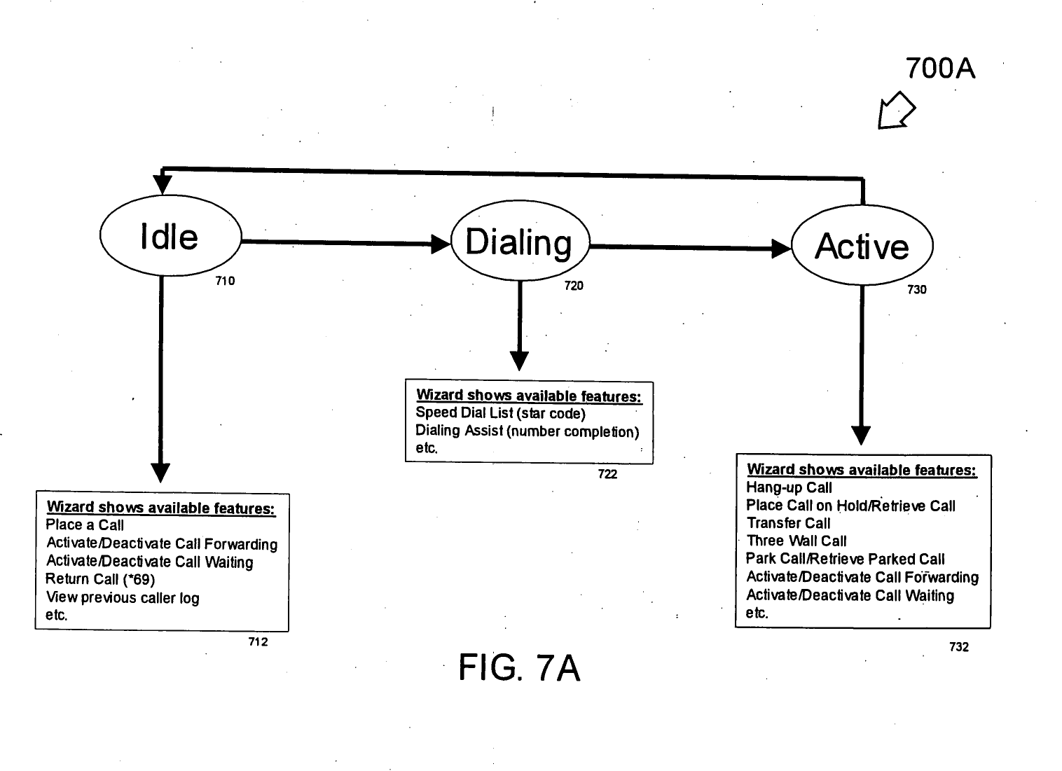

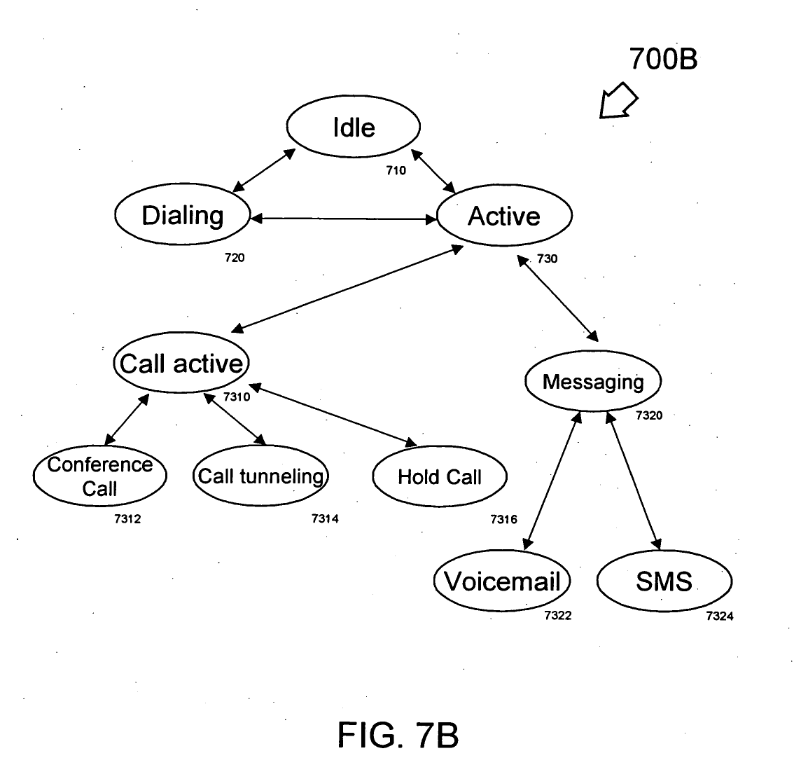

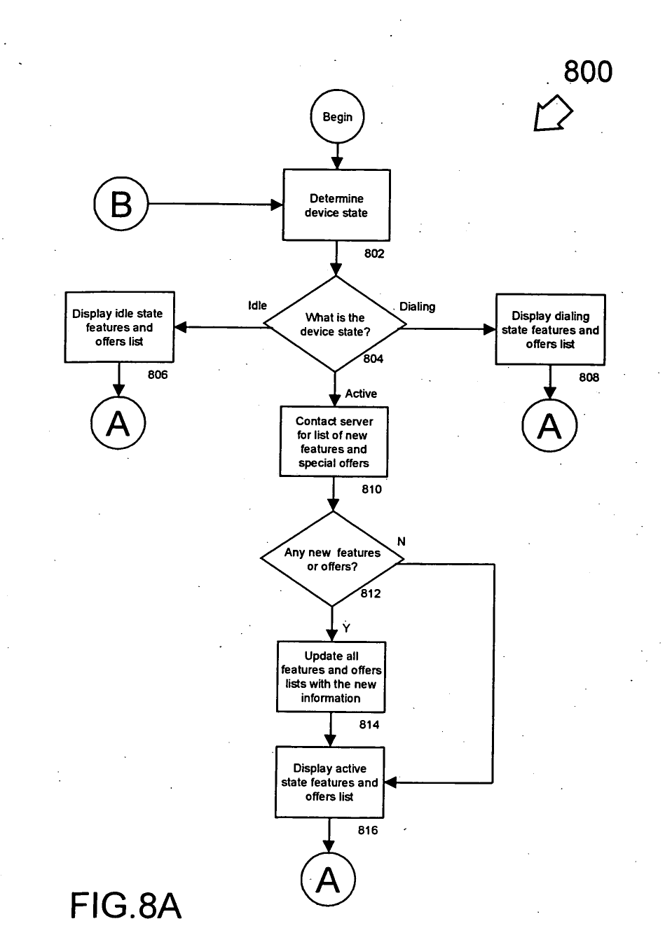

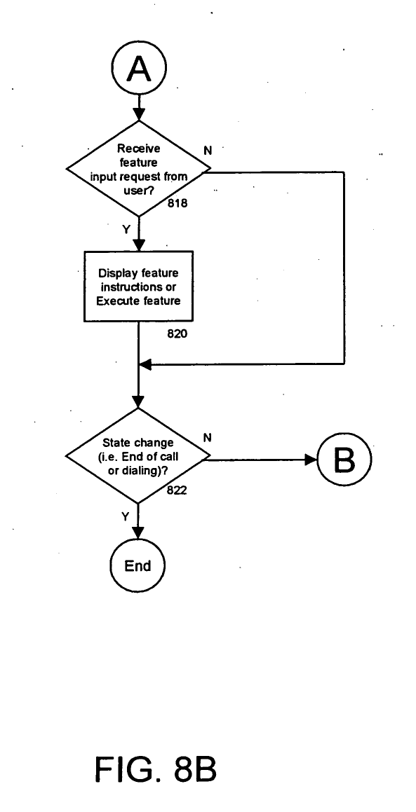

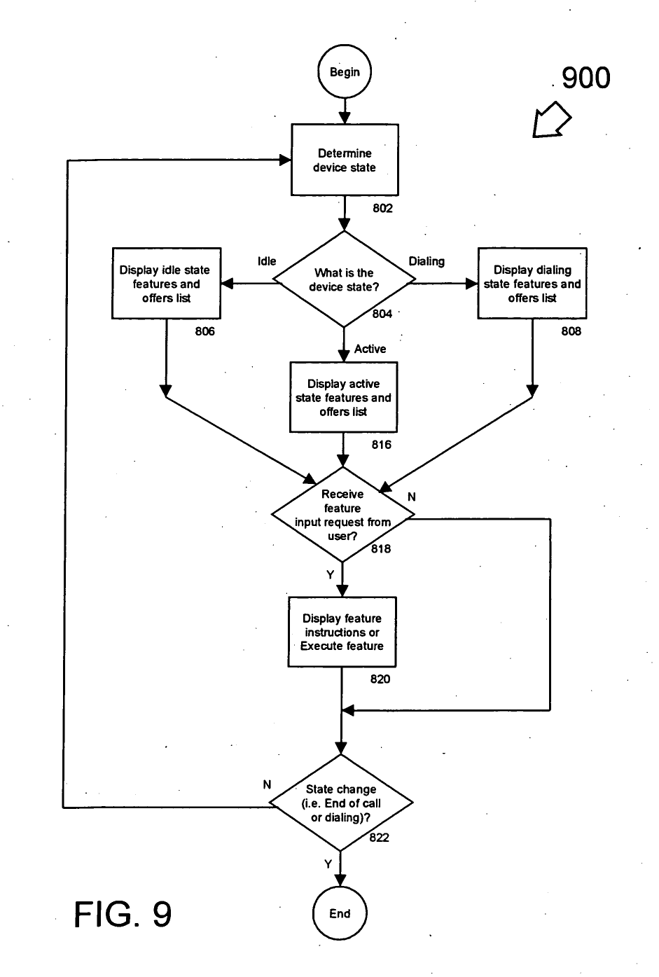

These components of call handler 210 interact with a voicemail database 242, known caller database 244, and telephony documentation 246, and may best be understood with respect to the example embodiments of FIGS. 5A-5D, and 6, state diagrams of FIGS. 7A-7B, and flowcharts of FIGS. 8A-8B, and 9, as described below.

Embodiments will now be disclosed using examples example embodiments of internet access devices 120. It is understood that these examples, which are used for illustrative purposes only, in no way limit available implementations or types of states available.

FIGS. 7A-7B depict state diagrams of a context-sensitive internet access device 120 that enables users to take advantage of new and existing telephony features, constructed and operative in accordance with an embodiment of the present invention.

FIG. 7A illustrates a simple state embodiment 700A in which a context-sensitive internet access device 120 has three states, idle 710, dialing 720, and active 730. It is understood that the three states are shown for exemplary purposes only, and that other states may be added without inventive faculty. Other states include, but are not limited to, ringing, off-hook, on-hold, call tunneling, and conference call states.

The idle state 710 is the state when the internet access device 120 is neither participating in a call nor attempting to connect a call. When the idle state 710 is detected by the call state monitor 220, telephony wizard 222 displays telephony documentation 246 pertaining to the idle state 710, block 712.

The dialing state 720 is when the internet access device 120 is attempting to contact a call recipient, i.e. attempting to connect a call. When the dialing state 720 is detected by the call state monitor 220, telephony wizard 222 displays telephony documentation 246 pertaining to the dialing state 720, block 722.

The active state 730 is when the internet access device 120 is active in a call. When the active state 730 is detected by the call state monitor 220, telephony wizard 222 displays telephony documentation 246 pertaining to the active state 730, block 732.

FIG. 7B illustrates an embodiment 700B in which a context-sensitive internet access device 120 has multiple states that may be detected by the call state monitor 220.

In state embodiment 700B, internet access device 120 has multiple states in addition to idle 710, dialing 720, and active 730. As shown in FIG. 7B, active state 730 may also comprise sub-states, such as a call active 7310 and messaging 7320 sub-states. These “child” or sub-states may inherit characteristics from its “parent” state, similar to standard object-oriented design techniques, as is known in the art. Furthermore, each of the additional states may have associated child-sub-states. As shown, the call-active 7310 sub-state is depicted with conference call 7312, call tunneling 7314, and hold-call 7316 child states. Similarly, the messaging 7320 sub-state may have associated voicemail 7322 and short-messaging-service 7324 (“SMS”) sub-states. It is understood that any state, parent state, or child state may have telephony documentation 246 associated with it. It is understood that the states depicted are shown for exemplary purposes only, and that other states may be added without inventive faculty.

For the sake of simplicity, embodiments will now be described utilizing only three states, the idle 710, dialing 720, and active 730 states of FIG. 7A.

FIGS. 5A-5D depict a user interface of a context-sensitive apparatus device that enables users to take advantage of new and existing telephony features, constructed and operative in accordance with an embodiment of the present invention. In this embodiment of an enhanced “caller ID” box embodiment of an internet access device 120, the internet access device 120 user interface comprises a liquid crystal display (LCD) 106A, light emitting diodes (LEDs) 106B-C to indicate the mode of operation, and manual input buttons 108A-H.

Each figure illustrates an enhanced “caller ID” box embodiment of the internet access device 120 operating in one of three states, the idle 710, dialing 720, and active 730 states.

FIG. 5A illustrates internet access device 120 operating in the idle 710 state. When the phone is idle, internet access device 120 displays telephony documentation 246 relevant to the idle state 710. The telephony documentation 246 illustrate the features available to the phone user while the phone is idle 710. In some embodiments, advertisements or reminders may also be displayed. For example, as shown in FIG. 5A, the telephony documentation may display help documentation on placing or forwarding calls, a phone list enabling returning a phone call, or a reminder for users to call their mother, is displayed. The reminder, or other advertisements related to new and existing calling features may be retrieved and displayed depending upon the call state. In some embodiments, the relevant message may include a list of features including a star codes prompting the use of a “*-number-number” combination to activate a telephone feature. In other embodiments, the telephony documentation may include computer software code to automatically dial the star code to implement the desired feature.

FIG. 5B illustrates internet access device 120 retrieving a list of calls while in idle 710 state. In this state, call hander 210 may display information from the list of stored callers in caller database 244, or callers that left voicemail messages in voicemail database 242.

FIG. 5C illustrates internet access device 120 operating in the dialing 720 state. While the phone is dialing, the internet access device 120 is in the dialing 720 state, and displays features available while the phone is dialing, or telephony documentation 246 information on how to utilize such features. The embodiment in FIG. 5C also illustrates the display of star codes prompting the use of a “*-number-number” combination to activate a telephone feature that may be used while in the dialing 720 state. In this particular instance the star code is used for speed dial assist, but it is understood that other star codes could be alternated without inventive faculty. For example, the use of “*69” could be used to initiate a return phone call to the last calling party.

FIG. 5D illustrates internet access device 120 operating in the active 730 state. During the active 730 state, the internet access device 120 displays telephony documentation 246 available while the phone is actively communicating with network 110. Telephony documentation 246 includes options, features, and messages related to the state of the internet access device 120 or a connected telephone 10. As shown in FIG. 5D, downloadable messages highlighting new features, or promotions for existing features (i.e. a message stating “park call for only 95¢/min”) may be among the related messages.

FIG. 6 depicts a user interface of a context-sensitive internet access device 120 that enables users to take advantage of new and existing telephony features, constructed and operative in accordance with an embodiment of the present invention, wherein the internet access device 120 is a telephone. In this phone embodiment, the internet access device 120 user interface comprises a liquid crystal display (LCD) 106, and manual input buttons 108A-Q. In a phone embodiment, the internet access device 120 behaves similarly to the caller ID box implementation, except that the device states are dictated by the device 120 itself, instead of an attached telephone 10. The internet access device 120 of FIG. 6 is depicted in the active 730 state.

FIGS. 8A-8B flowchart a process 800 to facilitate users to take advantage of new and existing telephony features, constructed and operative in accordance with an embodiment of the present invention.

At act 802, call state monitor 220 determines the current call state of internet access device 120. The determination of the call state may depend upon the type of internet access device 120 embodiment. Internet access devices 120 that place calls determine their own state. Internet access devices 120 that facilitate the calls of other devices, such as a caller D box embodiment, determine the call state of an attached telephone.

At decision act 804, process flow is routed depending upon the previously determined state. For simplicity's sake, only three states are shown, however, as discussed above any number of states can be added.

If the internet access device 120 is operating in the idle 710 state, as determined by decision act 804, flow continues at act 806. When the phone is idle, telephony wizard 222 displays telephony documentation 246 relevant to the idle state 710 at display 106. The telephony documentation 246 illustrates the features available to the phone user while the phone is idle 710. In some embodiments, advertisements or reminders may also be displayed. For example, the telephony documentation may display help documentation on placing or forwarding calls, a phone list enabling returning a phone call, or a reminder for users to call their mother. The reminder or other advertisements related to new and existing calling features may be retrieved and displayed depending upon the call state. Flow continues at act 818 on FIG. 8B.

If the internet access device 120 is operating in the dialing 720 state, as determined by decision act 804, flow continues at act 808. While the phone is dialing, the internet access device 120 is in the dialing 720 state, and telephony wizard 222 displays features available while the phone is dialing, or telephony documentation 246 information on how to utilize such features. Flow continues at act 818 on FIG. 8B.

If the internet access device 120 is operating in the active 730 state, as determined by decision act 804, flow continues at act 810. In embodiments that use packet-switched communications, internet access device 120 communicates with a central location, such as telephony wizard server 135, to receive update telephony documentation 246 with an updated list of new features and special offers, and removing any expired telephony documentation 246. Telephony wizard server 135 may be any device that sends an internet access device 120 new telephony documentation 246. If any updates are found at act 812, the telephony documentation 246 is updated, at act 814, and the telephony wizard 222 displays the active 730 state telephony documentation 246, act 816. Flow continues at act 818 on FIG. 8B.

Moving to FIG. 8B, at act 818, internet access device 120 determines whether it has received an input request from the user. If so, either the associated feature instructions from the telephony documentation are shown, or the feature is executed at act 820.

At decision act 822, call state monitor 220 determines whether a state change has occurred as a result of the execution of the new feature, and the process 800 either ends or restarts.

FIG. 9 flowcharts an alternate embodiment, process 900, to facilitate users to take advantage of new and existing telephony features, constructed and operative in accordance with an embodiment of the present invention. Process 900 is an embodiment that lacks the telephony documentation 246 update feature.

At act 802, call state monitor 220 determines the current call state of internet access device 120. The determination of the call state may depend upon the type of internet access device 120 embodiment. Internet access devices 120 that place calls determine their own state. Internet access devices 120 that facilitate the calls of other devices, such as a caller ID box embodiment, determine the call state of an attached telephone.

At decision act 804, process flow is routed depending upon the previously determined state. For simplicity's sake, only three states are shown, however, as discussed above any number of states can be added.

If the internet access device 120 is operating in the idle 710 state, as determined by decision act 804, flow continues at act 806. When the phone is idle, telephony wizard 222 displays telephony documentation 246 relevant to the idle state 710 at display 106. The telephony documentation 246 illustrates the features available to the phone user while the phone is idle 710. In some embodiments, advertisements or reminders may also be displayed. For example, the telephony documentation may display help documentation on placing or forwarding calls, a phone list enabling returning a phone call, or a reminder for users to call their mother, is displayed. The reminder or other advertisements related to new and existing calling features may be retrieved and displayed depending upon the call state. Flow continues at act 818.

If the internet access device 120 is operating in the dialing 720 state, as determined by decision act 804, flow continues at act 808. While the phone is dialing, the internet access device 120 is in the dialing 720 state, and telephony wizard 222 displays features available while the phone is dialing, or telephony documentation 246 information on how to utilize such features. Flow continues at act 818.

If the internet access device 120 is operating in the active 730 state, as determined by decision act 804, flow continues at act 816. The telephony wizard 222 displays the active 730 state telephony documentation 246, act 816. Flow continues at act 818.

At act 818, internet access device 120 determines whether it has received an input request from the user. If so, either the associated feature instructions from the telephony documentation are shown, or the feature is executed at act 820.

At decision act-822, call state monitor 220 determines whether a state change has occurred as a result of the execution of the new feature, and the process 900 either ends or restarts.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1-22. (canceled)

23. An apparatus comprising:
a call state monitor configured to passively determine a call state of a device, the call state monitor not having a separate telephone number from the apparatus; and
a telephony wizard, coupled to the call state monitor, configured to identify a list of telephony documentation available during the call state, the telephony documentation including at least one from the list consisting of telephony feature descriptions, telephony feature invocation directions, and telephony feature-related advertisements.

24. The apparatus of claim 23, wherein the telephony wizard is further configured to download an update to the list of telephony documentation.

25. The apparatus of claim 24, wherein the call state of the device comprises idle, dialing, and active states.

26. The apparatus of claim 25, wherein the telephony wizard is configured to automatically dial a star code when an available telephony feature is selected.

27. The apparatus of claim 26, wherein the call state monitor determines a call state of an external device.

28. A method comprising:
passively determining a call state of a device without a separate telephone number from the device;
displaying a list of telephony documentation available during the call state, the telephony documentation including at least one from the list consisting of telephony feature descriptions, telephony feature invocation directions, and telephony feature-related advertisements.

29. The method of claim 28, further comprising:
downloading an update to the list of telephony documentation.

30. The method of claim 29, wherein the call state of the device comprises idle, dialing, and active states.

31. The method of claim 30, further comprising:
automatically dialing a star code when an available telephony feature is selected.

32. A method comprising:
passively determining a call state of a device without a separate telephone number from the device, the call states including an active call state;
displaying a list of telephony documentation of an available telephony feature during the active call state, the telephony documentation including at least one from the list consisting of telephony feature descriptions, telephony feature invocation directions, and telephony feature-related advertisements.

33. The method of claim 32, further comprising:
downloading an update to the list of telephony documentation.

34. The method of claim 33, wherein the telephony documentation includes a star code for the available telephony feature.

35. The method of claim 34, further comprising:
automatically dialing the star code when the available telephony feature is selected.

36. The method of claim 35, wherein the call state of the device further includes idle and dialing.

37. A computer-readable medium encoded with data and instructions, the data and instructions causing an apparatus executing the instructions to:
passively determine a call state of a device without a separate telephone number from the device, the call state including an active call state;
display a list of telephony documentation of an available telephony feature during the active call state, the telephony documentation including at least one from the list consisting of telephony feature descriptions, telephony feature invocation directions, and telephony feature-related advertisements.

38. The computer-readable medium of claim 37, further encoded with data and instructions, the instructions further causes a computer to:
download an update to the list of telephony documentation.

39. The computer-readable medium of claim 38, wherein the telephony documentation includes a star code for the available telephony feature.

40. The computer-readable medium of claim 39, further encoded with data and instructions, the instructions further causes a computer to:
automatically dial the star code when the available telephony feature is selected.

41. An apparatus comprising:
means for passively determining a call state of a device without a separate telephone number from the apparatus, the call state including an active call state;
means for displaying a list of telephony documentation of an available feature during the active call state, the telephony documentation including at least one from the list consisting of telephony feature descriptions, telephony feature invocation directions, and telephony feature-related advertisements.

42. The apparatus of claim 41, further comprising:
means for downloading an update to the list of telephony documentation.

43. The apparatus of claim 42, wherein the telephony documentation includes a star code for the available feature.

44. The apparatus of claim 43, further comprising:
means for automatically dialing the star code when the available feature is selected.
